(19) United States
(12) Patent Application Publication
(10) Pub. No.: US 2013/0055291 A1
(43) Pub. Date: Feb. 28, 2013

(54) DESCRIBING NATIVE APPLICATION PROGRAMMING INTERFACES OF AN OPERATING SYSTEM WITH METADATA

(71) Applicants: Harold Pierson, Redmond, WA (US); Brent Rector, Redmond, WA (US); Martyn Lovell, Seattle, WA (US); Mahesh Prakriya, Redmond, WA (US); Stephen Rowe, Bellevue, WA (US); Tassaduq Basu, Redmond, WA (US); Robert A. Wlodarczyk, Issaquah, WA (US); Elliot H. Omiya, Kirkland, WA (US); Jerry Dunietz, Seattle, WA (US); Ales Holecek, Kirkland, WA (US); Lawrence W. Osterman, Woodinville, WA (US); Wei Zeng, Sammamish, WA (US); Neeraj Wadhwa, Kirkland, WA (US); Shakeel Solkar, Sammamish, WA (US); Michael Aksionkin, Redmond, WA (US)

(72) Inventors: Harold Pierson, Redmond, WA (US); Brent Rector, Redmond, WA (US); Martyn Lovell, Seattle, WA (US); Mahesh Prakriya, Redmond, WA (US); Stephen Rowe, Bellevue, WA (US); Tassaduq Basu, Redmond, WA (US); Robert A. Wlodarczyk, Issaquah, WA (US); Elliot H. Omiya, Kirkland, WA (US); Jerry Dunietz, Seattle, WA (US); Ales Holecek, Kirkland, WA (US); Lawrence W. Osterman, Woodinville, WA (US); Wei Zeng, Sammamish, WA (US); Neeraj Wadhwa, Kirkland, WA (US); Shakeel Solkar, Sammamish, WA (US); Michael Aksionkin, Redmond, WA (US)

(73) Assignee: Microsoft Corporation, Redmond, WA (US)

(21) Appl. No.: 13/223,291

(22) Filed: Aug. 31, 2011

(51) Int. Cl. G06F 9/44

(52) U.S. Cl. 719/328

(57) ABSTRACT

Native operating system application programming interfaces (API's) are described using metadata and such descriptions are stored in a standard file format in a known location. By storing API definitions using such metadata, other applications can readily identify and use the APIs. To create such API representations, during development, a developer describes the shape of the API, including (but not limited to) the classes, interfaces, methods, properties, events, parameters, structures and enumerated types defined by the API. This API description is processed by a tool which generates a machine-readable metadata file. The machine-readable metadata file contains the same information as the API description, however in a format designed to be machine read rather than human authored.

### BACKGROUND

An operating system typically has several application programming interfaces that allow applications to access functionality supported by the operating system. Such APIs are typically specified by an operating system using a named file or object in a computer programming language. For example, the C programming language uses header files that may have a name such as “interface.h”. Similarly, in C# a mechanism called “P/Invoke” signatures is used to access operating system APIs. A person writing a computer program that will make use of an operating system API typically includes a reference to a named API file or object in the program, or uses another mechanism provided by the programming language. That program, for example, then includes calls to functions defined by that API, in the syntax used by that API.

APIs defined in this manner cannot be directly accessed by languages other than the languages they are written in. To be made accessible to programs written in other languages, APIs are “wrapped.” This wrapping typically has to be done manually per API and per language and requires deep understanding of both the target language and the API and operating system. Consequently, many operating system APIs are unavailable.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Native operating system application programming interfaces (API's) are described using metadata and such descriptions are stored in a standard file format in a known location. By storing API definitions using such metadata, other applications can readily identify and use the APIs.

To create such API representations, during development, a developer describes the shape of the API, including (but not limited to) the classes, interfaces, methods, properties, events, parameters, structures and enumerated types defined by the API. This API description is processed by a tool which generates a machine-readable metadata file. The machine-readable metadata file contains the same information as the API description, however in a format designed to be machine read rather than human authored. For example, this machine-readable metadata file can be stored in ECMA-335 CLI format.

When the operating system is built, all of the individual API descriptions are compiled into individual metadata files. These metadata files are combined together to provide comprehensive information about all the APIs available within the system. This combined metadata is included in the operating system image (i.e., a compiled binary file) for installation. For example, the combined system metadata can be stored in a series of metadata files in the ECMA-335 CLI format, but the specific format is immaterial to the invention. In this manner, the operating system and its APIs are self-describing.

By having an operating system for which the APIs are fully described by programming language independent metadata, it is possible to build a language projection, which is an application that reads the metadata and implements the API in another programming language. For example, a JavaScript interpreter can include such a language projection and automatically provide access by JavaScript programs to the operating system APIs. Programs in compiled languages can be provided similar access by a compiler that includes such a language projection. If, in a subsequent release, the operating system adds new APIs, the metadata distributed with the new release enables applications to instantly take advantage of the new functionality without modifications to the interpreter or compiler.

Accordingly, in one aspect, an operating system of a computer comprises computer program instructions stored on computer storage media which, when processed by a processing device, instruct the processor to perform operations that implement the operating system. The operating system has one or more application programming interfaces accessible by application programs for providing access for the application programs to functionality implemented by the operating system. A metadata file describes named elements of the application programming interface in a machine readable programming language independent format. A named element can be or include any of a variety of data types, such as basic types, enumerated types, structures, delegates, interfaces, classes, methods, properties and events. The metadata file can include, for each named element of an application programming interface, an identifier (or type name) which is located in a name space.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example operating system with metadata describing application programming interfaces.

FIG. 2 is a data flow diagram illustrating an example implementation of development tools for building the operating system with metadata describing application programming interfaces.

FIG. 3 is a flow chart illustrating an example of how API description files can be processed to generate metadata.

FIG. 4 is a block diagram of an example computing device in which such a system can be implemented.

### DETAILED DESCRIPTION

The following section provides an example operating environment in which such an operating system can be implemented.

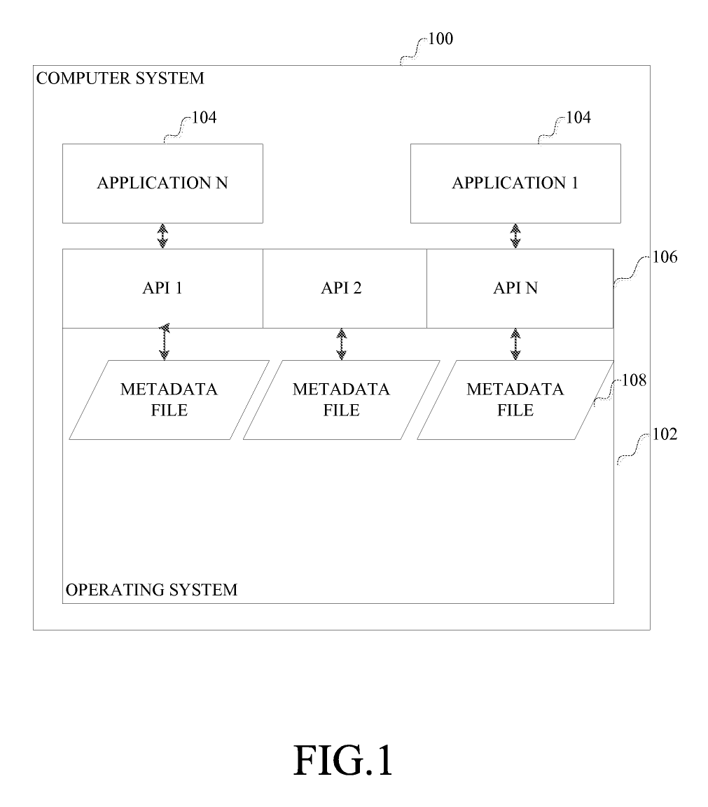

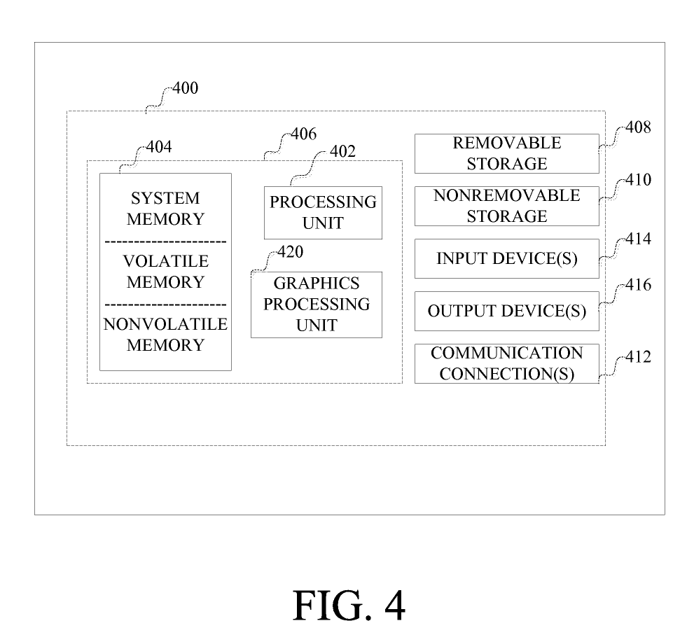

Referring to FIG. 1, a computer system 100 includes an operating system 102 that, in combination with computer hardware (see FIG. 4), provides a platform on which various applications 104 are run. Applications are run as processes managed by the operating system, and they consume or otherwise have access to resources of the computer system that are managed by the operating system, such as files, etc.

The operating system provides several application programming interfaces 106 that are accessed by the applications 104. These API's 106 are described by one or more metadata files 108. The metadata files 108 are a machine readable, programming language independent representation of the API or APIs of the operating system. As described below, such metadata files can be created automatically from API description files, thus allowing the automatic generation of a machine readable, programming language independent description of the surface, or full APIs, of the operating system. Such metadata files, combined with language compilers and/or interpreters (not shown) allow the applications 104 to be developed in a manner in which the operating system APIs are projected into the programming languages in a natural and automatic way.

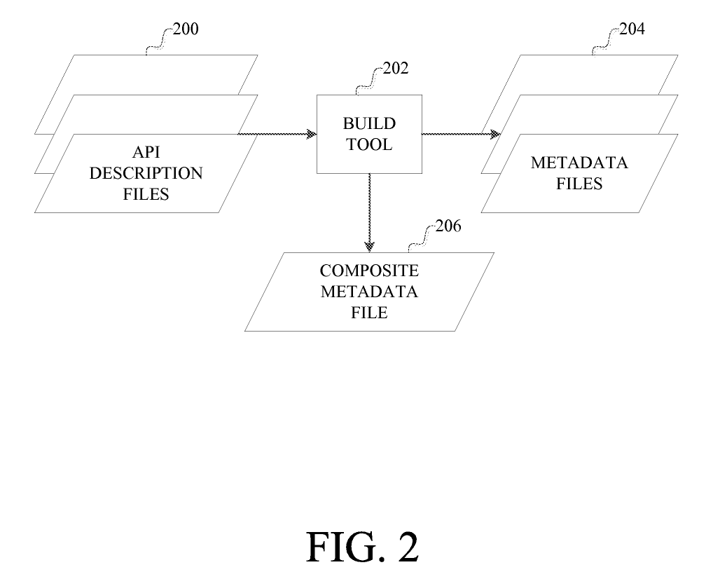

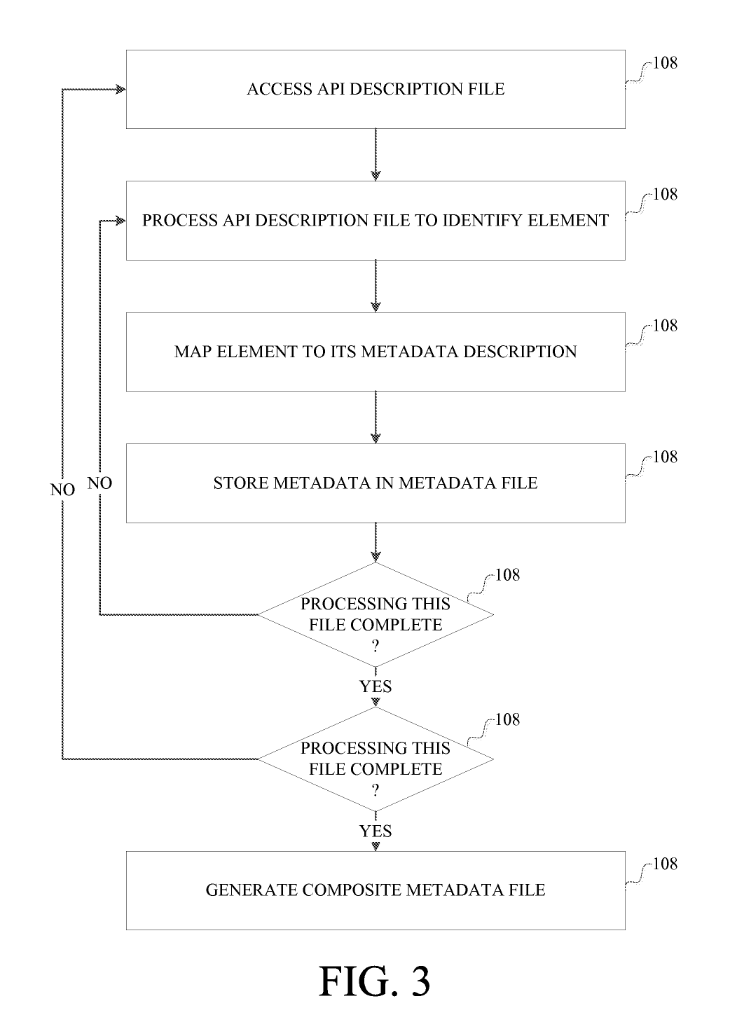

Given this context, an example implementation of such an operating system will be described in more detail in connection with FIGS. 2 and 3.

In FIG. 2, an example data flow for application development is shown. Application programming interface description files 200 are defined by developers during the development process, i.e., the process of writing code that implements the operating system.

A build tool 202, used to compile the code for the operating system into executables to be installed on a computer system, processes the API description files to generate the metadata files 204. Finally, the build tool 202 combines the metadata files 204 into a combined metadata file 206.

Any implementation of a build tool 202 is dependent on the programming language and any specification for the API description files 200. Such API description files 200 can define interfaces that are functions or object classes or data structures, and can define one or more methods, events, properties, parameters, data types, parameter ordering, exceptions and the like for such interfaces. The build tool parses such API description files, identifies the characteristics of the interface, and stores data representing such characteristics in a machine readable, programming language independent format, in metadata files.

FIG. 3 illustrates a general example process performed by a build tool. The build tool accesses 300 an API description file. It processes 302 the API description file, identifying named elements of the API, such as classes, method, data types, properties, events, exceptions and the like. The identified named element is mapped 304 to its metadata representation. This metadata representation is stored 306 in a metadata file corresponding to the API description file. Until the API description file is completely processed, as determined in 308, steps 302 through 308 are repeated. After processing the API description file, another API description file (if any, as determined at 310), is accessed 300, and steps 302 through 308 are repeated for that file. When processing of all API description files has completed, then a composite metadata file is created 312. For example, the combined system metadata can be stored in a series of metadata files in the ECMA-335 CLI format, but the specific format is immaterial to the invention. This combined metadata file thus provides a complete, automatic, programming language independent description of the surface, i.e., the available interfaces, of the operating system.

Example mappings that can be used in step 304 will now be described. It should be understood that other mappings are possible, in terms of both form and structure of the metadata used to represent a named element in an API. In this example implementation, mapping an API description file to metadata involves first identifying named elements in the API description file. A named element can be or include any of a variety of data types, such as basic types, enumerated types, structures, delegates, interfaces, classes, methods, properties and events. The metadata file can include, for each named element of an application programming interface, an identifier (or type name) which is located in a name space.

In this implementation, every named element can be or can include any of a variety of data types, and has an identifier located within a namespace. Two named elements can have the same identifier so long as they exist in separate namespaces. When an API file that specifies the API uses a named element, such as in a parameter or struct field, the author of the file can use the fully namespace-qualified name or the short identifier. If the short identifier is used, a fully namespace-qualified name is used in the metadata by appending the short identifier onto the currently namespace scope. Using this mechanism, there is no way that a name can be ambiguous in the metadata. Namespace blocks can be used in the metadata, and these blocks can be nested, to avoid explicitly declaring the namespace on every named element within the block. A named element can be tagged with attributes. Example attributes include, but are not limited to, a version number, a simple flag, or they can contain additional information in parameters.

Turning now to example representation details, named elements that are fundamental types can be represented by an keyword consistent with that fundamental type, such as a Boolean, byte, double, float, int, long, short, character, string, guid, handle, error status, etc., followed by the identifier used in the API description file. For example, a Boolean representing a value called “answer” would be represented as:

“Boolean Answer”

An example representation of an array is the following. It has a general form of a keyword, such as “array,” followed by an identifier. This is followed by the pair of values being a pointer, and a number of elements in the array. For example:

array [identifier]
{
[pointer]
[number of elements]
}

An example representation of an enumerated type (“Enum”) is the following. First, it has a general form with the keyword “enum” that identifies an enumerated type, followed by an identifier. The identifier is followed by a collection of enum values. Like all types, enum identifiers are unique within the namespace they are contained in. However, enum value identifiers can be unique only within the enum itself.

enum [identifier]
{

[value 1 identifier] [optional: = value], . . .
[value n identifier] [optional: = value]

}
As an example, using rankings of playing cards:
enum CardRank
{

Ace = 1,
Two, Three, Four, Five, Six, Seven, Eight, Nine, Ten, Jack,
Queen, King

}

An example representation of a simple data structure type (“struct”) is the following. First, it has the general form with a structure type specifier, followed by a collection of fields, each of which has a type and an identifier. Like all types, struct identifiers are unique within the namespace they are contained in. However, struct field identifiers can be unique only within the struct itself.

[version([version number])]
struct [struct.identifier]
{

[field[1] type] [field[1] identifier];
[field[n] type] [field[n] identifier];

};
As a specific example of a struct for arguments for a mouse event:
[version(OS.version.number)]
struct MouseEventArgs
{

```
  MouseButtons Buttons;
  unsigned int Clicks;
  unsigned int Delta;
  Point Location;
```

}

An example representation of an interface is a collection of methods, properties or events. The implementation of the methods can be done in a class that implements the interface. In addition to the common attributes, interfaces use a UUID attribute to be specified. An interface can “require” another interface. This signifies that if a component implements a given interface, all “required” interfaces also are implemented by the same component. An example grammar for representing an interface is as follows:

interface:

| attributes “interface” IDENTIFIER ‘:’ IDENTIFER requires
‘{‘interface_member_list’}’

requires:

| <empty>
| “requires” interface_list

interface_list:

| IDENTIFIER
| IDENTIFIER “,” interface_list

interface_member_list:

| <empty>
| interface_member
| interface_member interface_member_list

interface_member:

| method
| property
| event

In this example implementation, at the end of the representation of an interface are methods, properties and/or events. In this example, interfaces can contain methods which take zero or more parameters and return a single type. The return type of a method is HRESULT. Parameters have a name and a type. Parameters are marked with either the [in] or [out] attribute. There can be any number of input and output parameters. Parameters can be marked as both input and output for all RIDL-supported pointer types. A single output parameter can optionally be marked with [retval] for languages that map HRESULT return values to exceptions. Method names within an interface are unique.

Also in this example implementation properties can appears similar to fields, but are associated with the input and output parameters of the put and get operations used to access them.

Interfaces support events, a mechanism for the interface to notify interested parties when something of interest happens. The representation includes a specification of an add method and a specification of a remove method. The add method has a first parameter that is an input parameter of the event delegate type and a second parameter that is an output parameter of type EventRegistrationToken. The remove method has a first parameter that is an input parameter of type EventRegistrationToken. The event delegate type itself for an event has a first parameter that is an interface pointer to the event source, i.e. an object that sends this event. The following is an example that shows how the delegate type MouseEventHandler can be used to declare interface events.

[eventadd] HRESULT MouseMove(
[in] MouseEventHandler *pMouse,
[out] EventRegistrationToken* token);
[eventremove] HRESULT MouseMove(
[in] EventRegistrationToken token).

Delegates can be represented as an interface with a single method Invoke whose signature matches the signature of the delegate specification. The method has a single return type and zero or more parameters. The return type of a delegate is HRESULT. Parameters have a name and a type. Parameters are marked as either input or output. There can be any number of input and output parameters. A single output parameter can optionally be marked as the return value for languages that map HRESULT return values to exceptions. An example grammar for representing a delegate is the following:

delegate: |delegate_attributes “delegate” TYPE_IDENTIFIER IDENTIFIER ‘(‘parameter_list’)”;’

It should be understood that the foregoing are merely examples of how elements of an API can be represented in programming language independent metadata. A variety of metadata representations can be used.

By having an operating system for which the APIs are fully described by programming language independent metadata, it is possible to build a language projection, which is an application that reads the metadata and implements the API in another programming language. For example, a JavaScript interpreter can include such a language projection and automatically provide access by JavaScript programs to the operating system APIs. Programs in compiled languages can be provided similar access by a compiler that includes such a language projection.

Having now described an example implementation, an example computing environment in which such a system is designed to operate will now be described. The following description is intended to provide a brief, general description of a suitable computing environment in which this system can be implemented. The system can be implemented with numerous general purpose or special purpose computing hardware configurations. Examples of well known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

FIG. 4 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 4, an example computing environment includes a computing machine, such as computing machine 400. In its most basic configuration, computing machine 400 typically includes at least one processing unit 402 and memory 404. The computing device may include multiple processing units and/or additional co-processing units such as graphics processing unit 420. Depending on the exact configuration and type of computing device, memory 404 may be volatile (such as RAM), non-volatile (such as ROM, flash memory, etc.) or some combination of the two. This most basic configuration is illustrated in FIG. 4 by dashed line 406. Additionally, computing machine 400 may also have additional features/functionality. For example, computing machine 400 may also include additional storage (removable and/or non-removable) including, but not limited to, magnetic or optical disks or tape. Such additional storage is illustrated in FIG. 4 by removable storage 408 and non-removable storage 410. Computer storage media includes volatile and nonvolatile, removable and non-removable media implemented in any method or technology for storage of information such as computer program instructions, data structures, program modules or other data. Memory 404, removable storage 408 and non-removable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 400. Any such computer storage media may be part of computing machine 400.

Computing machine 400 may also contain communications connection(s) 412 that allow the device to communicate with other devices. Communications connection(s) 412 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 400 may have various input device(s) 414 such as a display, a keyboard, mouse, pen, camera, touch input device, and so on. Output device(s) 416 such as speakers, a printer, and so on may also be included. All of these devices are well known in the art and need not be discussed at length here.

Such an operating system with metadata describing application programming interfaces can be implemented in the general context of software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote processing devices that are linked through a communications network. In a distributed computing environment, program modules may be located in both local and remote computer storage media including memory storage devices.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. An article of manufacture comprising:
one or more computer storage media;
computer program instructions stored on the computer storage media which, when processed by a processing device, instruct the processor to perform operations, wherein the instructions include operations that provide an operating system through which an application accesses resources of the computing machine, wherein the operating system provides:
one or more application programming interfaces accessible by application programs for providing access for the application programs to functionality implemented by the operating system; and
wherein each of the application programming interfaces has an associated metadata file, wherein the metadata file describes elements of the application programming interface in a machine readable programming language independent format.

2. The article of manufacture of claim 1, wherein the metadata file includes, for named elements of the application programming interface, an identifier located in a name space.

3. The article of manufacture of claim 2, wherein named elements can be one of a set of fundamental data types.

4. The article of manufacture of claim 3, wherein named elements can further be one of interfaces, methods, properties and events.

5. The article of manufacture of claim 3, wherein named elements can further be one of data structures, enumerated types and arrays.

6. The article of manufacture of claim 3, wherein named elements can further be delegates.

7. A computing machine comprising:
a processor;
one or more computer storage media;
computer program instructions stored in the computer storage media that, when processed by the processor, instruct the processor to perform operations, wherein the instructions include operations that provide an operating system through which an application accesses resources of the computing machine, wherein the operating system provides:
one or more application programming interfaces accessible by application programs for providing access for the application programs to functionality implemented by the operating system; and
wherein each of the application programming interfaces has an associated metadata file, wherein the metadata file describes elements of the application programming interface in a machine readable programming language independent format.

8. The computing machine of claim 7, wherein the metadata file includes, for named elements of the application programming interface, an identifier located in a name space.

9. The computing machine of claim 8, wherein named elements can be one of a set of fundamental data types.

10. The computing machine of claim 9, wherein named elements can further be one of interfaces, methods, properties and events.

11. The computing machine of claim 9, wherein named elements can further be one of data structures, enumerated types and arrays.

12. The computing machine of claim 9, wherein named elements can further be delegates.

13. A computer-implemented process comprising:
receiving a data file defining an application programming interface for providing access for application programs to functionality implemented by an operating system; and
generating for the application programming interface an associated metadata file, wherein the metadata file describes elements of the application programming interface in a machine readable programming language independent format; and
storing the metadata file as part of the operating system.

14. The computer implemented process of claim 13, wherein the metadata file includes, for named elements of the application programming interface, an identifier located in a name space.

15. The computer implemented process of claim 14, wherein named elements can be one of a set of fundamental data types.

16. The computer implemented process of claim 15, wherein named elements can further be one of interfaces, methods, properties and events.

17. The computer implemented process of claim 15, wherein named elements can further be data structures.

18. The computer implemented process of claim 15, wherein named elements can further be delegates.

19. The computer implemented process of claim 15, wherein named elements can further be enumerated types.

20. The computer implemented process of claim 15, wherein named elements can further be arrays.
